(19) United States
(12) Patent Application Publication
(10) Pub. No.: US 2013/0031611 A1
(43) Pub. Date: Jan. 31, 2013

(54) CLOUD-ENABLED WEB-ENTRY SYSTEM FOR VISITOR ACCESS CONTROL

(71) Applicant: Hernando Barreto, Miami, FL (US)

(72) Inventor: Hernando Barreto, Miami, FL (US)

(21) Appl. No.: 13/549,409

(22) Filed: Sep. 27, 2012

Related U.S. Application Data
(60) Provisional application No. 61/507,457, filed on Jul. 13, 2011.

(51) Int. Cl. G06F 21/00

(52) U.S. Cl. 726/4

(57) ABSTRACT

The present invention is for a web-enabled entry system for access control of visitors to a residential, commercial or institutional facility having or not receptionist at the entry point, where visitors to such facility should be authorized and/or the visit event should be recorded in a database. This web enabled entry system is for visitor self-registration, announcing and obtain access approval for coming into such facility by the means of a system including touch capable tablet computers, wireless communications, remote servers and methods to notify and validate users providing entry authorization. The system is also capable to provide video capture and streaming using a camera embedded in the tablet computer and with the use of an optional door controller the system allows remote opening of the door or gate. The system also can be optionally used to work in conjunction with a receptionist or guard that will assist the visitor, providing a temporary visitor badge. The system on this invention can replace the use of traditional unattended telephone entry (tele-entry) system or manned computer based visitor control systems typically assisted by a guard or receptionist.

### FIELD OF INVENTION

The present invention relates to access control of visitors to residential (building or gated communities), commercial (office buildings or industrial complexes) or institutional (education, hospitals or government) facilities having or not receptionist at the entry point. More particularly the field of this invention is related to facilities that desire or need to control the access of visitors based on the authorization of tenants (residents or employees) at the facility using electronic or computer means to record, track and validate access of visitors to such facilities.

### BACKGROUND OF INVENTION

A typical commercial, residential or institutional building or facility handle visitor access control in different ways, depending if the facility is provided or not with receptionist or guard. One of the most popular systems, typically in the absence of a guard or receptionist, is the use of a telephone entry systems or tele-entry systems (TES), which are equipped with a directory of tenants (residents or employees of the facility) a keypad for the visitor to find the tenant and call handling electronics to generate a call to the tenant; the tele-entry also has means to activate a locking device to remotely open the door or gate at the access point.

When the entrance is provided with a receptionist or guard, typically there is a computer based system with software inside that allows the receptionist to search for the tenant in a directory, call to announce the visitor and if approved allow visitor to come in; optionally the receptionist would print a temporary visitor badge. Such directory of tenants could be in a local or remote server and database and as an option the system could provide a camera to capture and record the photo of the visitor. If the tenant database is remotely located then the reception or guard house computer is typically hooked up to a computer network.

In today environment, many residents or employees at residential, commercial or institutional facilities, are not longer using traditional phone lines (POT or plain old telephone network) as primary communication channel; instead of they depends more and more on mobile voice calls, voice over internet protocol (VoIP), text messaging, instant messaging and e-mail among other ways of communication; and therefore traditional tele-entry and visitor access control systems are no longer good enough solutions for evolving security and communication needs.

The system on this invention can replace the use of traditional telephone entry (tele-entry) system or computer based visitor control systems typically assisted by a guard or receptionist.

### SUMMARY OF THE INVENTION

Web enabled entry system for visitor self-registration, announcing and obtaining access approval for coming into a facility. The system uses touch capable tablet computers, wireless communications, remote servers and methods to notify and validate identification and entry authorization. The system will be capable to provide video capture and streaming using a camera embedded in the tablet computer. An optional door controller can allow remote opening of the door, gate or access point directly or enabling an operator or receptionist to open the door. The system can optionally use a label printer to print visitor temporary paper badge.

An objective of this invention is to provide system and methods for access control of visitors that do not rely only on telephone lines and voice calls like predecessor telephone entry systems neither depends on wired physical networks and standard computers.

Other objective is to provide a system capable of using mobile and wireless communication at the visitor entry point and also wireless communication at the tenant or user level, where those communications can include e-mails, text messages, instant messages, video conferencing or any other electronic communication in addition to voice calls.

One more objective of this invention is to provide a system that could be easily adapted to different facility entry arrangement either provided with receptionist or not in contrast with prior art where different systems need to be deployed for different configurations of the facility entrance point.

Further objective of this invention is to provide a system that takes advantage of modern computer technology such as integrated tablet computers with touch enabled screens as well as cloud computing¹ based on web hosted of software as a service, which do not require software installed at the client side. ¹ Cloud computing according to Wikipedia, differs from the classic client-server model by providing applications from a server that are executed and managed by a client's web browser, with no installed client version of an application required.

### DESCRIPTION BASED IN THE DRAWINGS

As described in FIG. 1, the system will consist of a Tablet computer 10 (such as an iPad of Apple® Computer) having internally a front camera 12 and optional back camera 13, mounted in a pedestal 11, for desktop or self standing use, which is capable to connect to the Internet cloud 16 via wireless communication using WiFi™ connection or GSM™ (Global System for Mobile Communications) or any other equivalent wireless technology.

The Tablet 10 is directly connected using a web browser via Internet to a central Access Server 14, which will be running software to process all users requests having a database containing information of tenants, visitors and other access control parameters. The access server 14 in addition to connect with visitors tablet 10 also can connect via Web with the manager computer 22 and user (Tenant) computer 19 as well as with communications server 15.

The communication server 15 processes via Internet messages from and to the access server 14 and also runs software applications designed to send to, and receive from, messages with user communication devices such us user computer 19, mobile device 20 (such as cell phone or smart phone) or phone 21 (regular, ISDN² or VoIP³). The messages exchanged by communication server 15 will use Internet cloud 16, telephone Network 17, or mobile network 18 to communicate with user communication devices 19, 20 or 21, which comprises a variety of channels including SMS (Short Message Services) text messages, e-mail (electronic mail) messages, instant or chat messages⁴ and voice calls among others. ² ISDN Integrated Service Digital Network³ VoIP Voice over Internet Protocol⁴ Instant or chat messages like the one using services like Yahoo® or Skype® among many others.

The system could be provided with a door controller 23 which can also communicate via Internet cloud 16 with access server 14 receiving signals to activate an electrically operated locking device to release the door or gate 26 if the visitor entrance is approved by the tenant. The communication between the door controller 23 and the access server 14 is also done via Internet using TCP/IP⁵ protocol. The signal sent by the door controller 23 is typically a relay signal that energizes or removes energy to an electrically operated locking device 24 which will release the door 26 at the entry point. As an option, the door controller 23 may provide a supervisory input for a magnetic contact 27 that will indicate the status, open or close, of the door and also an ID tag⁶ reader 25 for controlled access of tenants. ⁵ TCP/IP means Transmission Control Protocol (TCP) and Internet Protocol (IP).⁶ ID Tag refers to an electronic card, radio-frequency device, barcode decal, fingerprint or any other identification device with a unique identification number or ID.

In this description a door 26 may refers to a standard manually operated door, automatically operated door, vehicular barrier gate, manual or automatic turnstile, motorized pedestrian or vehicular metal gate and any other physical access element used to restrict access to a facility or location.

Alternatively, in facilities that provide a person (receptionist or guard) at the entry point to greet and receive visitors, the system can provide a reception computer 29 and also a label printer 28 for temporary visitor badge printing. The reception computer 29 if provided, communicate with the access server 14 via Internet 19 using any web browser without requires of special software installed in such reception computer 29.

Once a visitor has received approval by tenant to access the facility, the receptionist person will receive an access granted message in the reception computer 29 and receptionist will be able to print a temporary visitor badge 28 if such feature was selected. Depending of the preference of the system manager the visitor badge printer could communicate directly to the tablet 10 without intervention of the receptionist.

The embedded front camera 12, in the tablet 10, can capture a picture of the visitor or even send streaming video of visitor face via Internet cloud 16 to the access server 14 and to user communication devices 19, 20 or 21 trough out the communication (comm.) server 15. The optional camera 13 can also take a picture of the identification document (ID) of the visitor if that feature is selected by the user organization. For the purpose of taking a document picture, the pedestal 11 will be provided with a special holder to place the document ID while visitor is processing his access request.

In this description a user organization refers to residential communities (home owner associations, condominium associations, cooperatives and the similar), office buildings, business offices, industrial complexes, education institutions, hospitals, healthcare offices, government buildings, data centers, airports, ports, transportation terminals and any other facility where visitors shall be recorded or authorized to get into such facility.

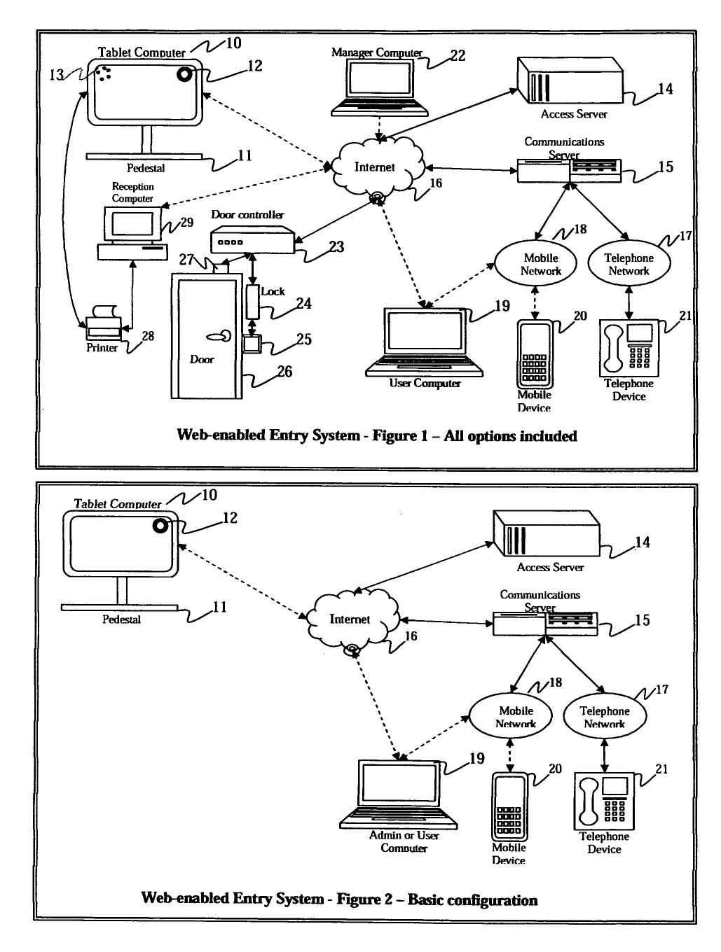

One of the objectives of this invention is to provide flexibility in the deployment of a visitor access control and therefore such a system could be deployed completely as illustrated in FIG. 1 or in a most simple configuration as depicted in FIG. 2.

The FIG. 2 shows simpler deployment with basic elements such us tablet 10, with optional pedestal 11 and camera 12, connected via Internet cloud 16 using wireless channel (WiFi™ or GSM™) to the Access Server 14 and communication server 15 to communicate back and for with user devices 19, 20 and 21. The dotted lines in FIG. 2 denote capability to use wireless communications.

Depending of the user organization requirements the tablet 10 could be operated while standing on pedestal 11 or could be operated as mobile device for visitor processing. Also depending of the size and traffic of visitor to the facility, the system can provide the use of multiple tablet computers 10 simultaneously to expedite processing of visitors.

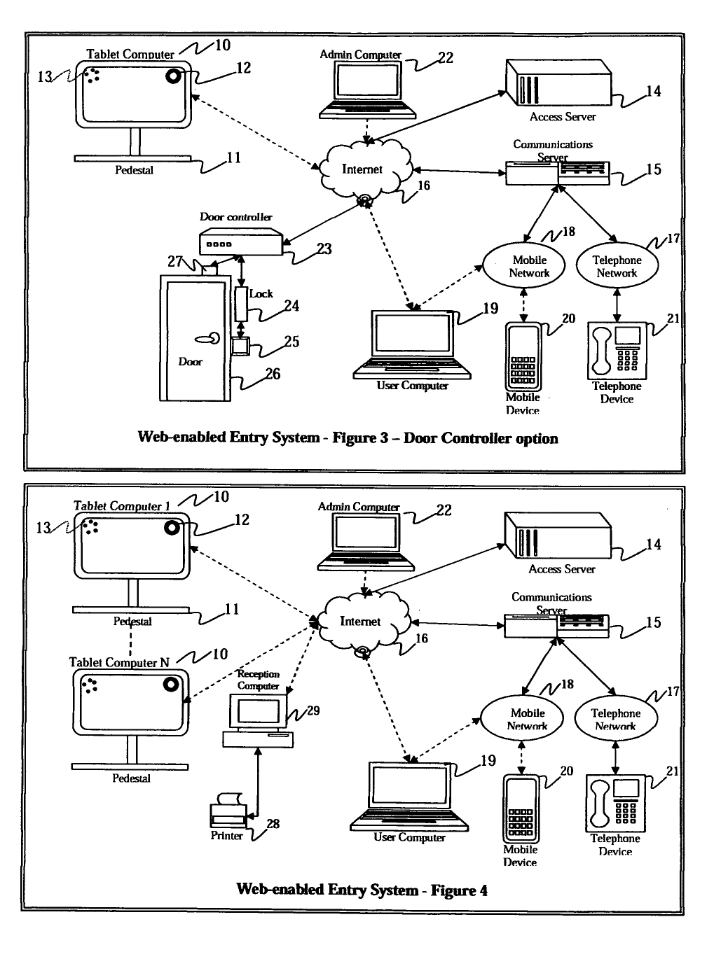

The FIG. 3 and FIG. 4, shows the flexibility of the design to allow alternative ways to deploy the system of this invention. The FIG. 3 depicts an implementation using same basic system as shown in FIG. 2 plus a door controller 23 and locking device 24 with optional accessories like tag ID reader 25 and door contact 27. The FIG. 4 shows a deployment considering multiple tablets and also a receptionist computer 29 with a temporary visitor badge printer 28. Many other configurations of the system can be deployed based on the facility arrangements for visitor entry having or not having receptionist or guard personnel.

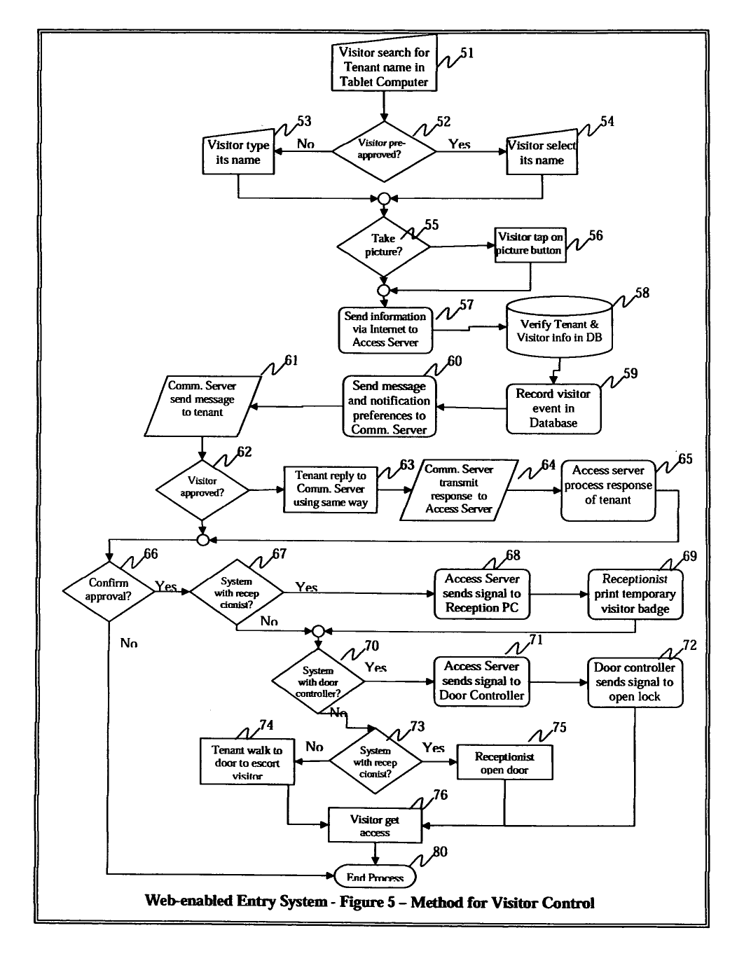

The FIG. 5 describes the method to announce, approve and get access of visitors by using the system components described above such us tablet touch capable computers, wireless communications, cloud hosted servers and web-enabled procedures. In the first step 51 of this method and process described in FIG. 5, the visitor approach the tablet 10 mounted in pedestal 11, provided with a web browser to access a graphic user interface (GUI) which will guide the visitor to find the name of the host (or tenant). There is no need of a directory hosted in the tablet computer 10 because the list of all tenants to such facility is maintained and permanently updated in the cloud hosted access server 14.

If visitor has been pre-approved or there is an appointment with the tenant 52, in the step 53 the system will display a list of approved visitors for that day on tablet 10 and then visitor only need select its name, otherwise visitor is prompted to enter his or her name.

If system has been configured to take a picture of visitor 55, then the step 56 will guide user to tap on a button of the touch tablet device 10 to take such picture. Alternatively the system could start taking live video streaming of visitor face.

In process 57 the information about tenant host, visitor and picture (or video) are sent to the access server 14; and then visitor and tenant information will be verified in the database 58 and the visit event will be recorded in the database 59. At step 60 the access server will send a message to the communication server containing visitor information to be forwarded 61 to the tenant using its communication channel of choice (e-mail, text message, instant message, voice call, video conference, etc).

If the visitor has not been pre-approved 62, the message to tenant will include a request for a response back 63 from tenant approving or declining visitor access. The response back from tenant will go on same path 64 to communication server and then 65 to access server using same channel. In other words, if message to tenant was a voice call then tenant can reply by pressing a key in his/her phone; if message was sent as a text message then response back will be a text message; if message was an instant message then response back will be an instant message; if the message was an e-mail then response back will be an e-mail and so on.

If visitor is approved 66 by tenant then system will go to next step 67. Otherwise if tenant is not approved the process will be ended 80.

As per step 67, if system is deployed with a receptionist then access server will send approval response 68 to reception computer and then receptionist would print temporary visitor badge 69. Otherwise, if there is no receptionist then system will go to next step 70.

In step 70 if system is deployed with a door controller then access server will send signal 71 to door controller and this in turn will send signal 72 to locking device to release the door and visitor will be allowed to get in 76 finishing the process 80. Otherwise if system is not provided with a door controller then tenant will walk to the door 75 to allow visitor access 76 finishing the process 80.

The FIG. 6 illustrates the method and process for tenant user to create an appointment and update the system access server with appointment date, time and visitor information. Using a regular web-browser (such as Internet Explorer®, Firefox®, Safari®, Chrome®, etc) the tenant user can interact 81 with the system and the first step will be to verify 82 if it is already registered in the system; if not then user can register with the user organization providing the required information 83. A direct user registration will be validated by a Manager 84 updating the system database 85 and then user will be able to use the system by entering its credentials 86.

Once tenant user is logged in the system, the user can edit or update its profile 88 and such changes will be updated 89 in the system database. The tenant user can also enter visitor and appointment information 90 among other functions. As the system will allow keeping contact names of previous visitors, the tenant user can verify 91 if such visitor name already exist and then just select 92 that visitor name; otherwise tenant user shall enter 93 visitor name and information.

The visit authorization or appointment data would be added 95 by user tenant directly from the web browser. Alternatively, tenant user can create the appointment info in his or her own calendar system application such as Microsoft® Outlook or Google® Calendar and then use a plugin⁷ provided by the system to synchronize its own calendar with the access server visitor schedule to update 96 the appointment data in the access server database. ⁷ Plugin is a set of software components that adds specific abilities to a larger software application.

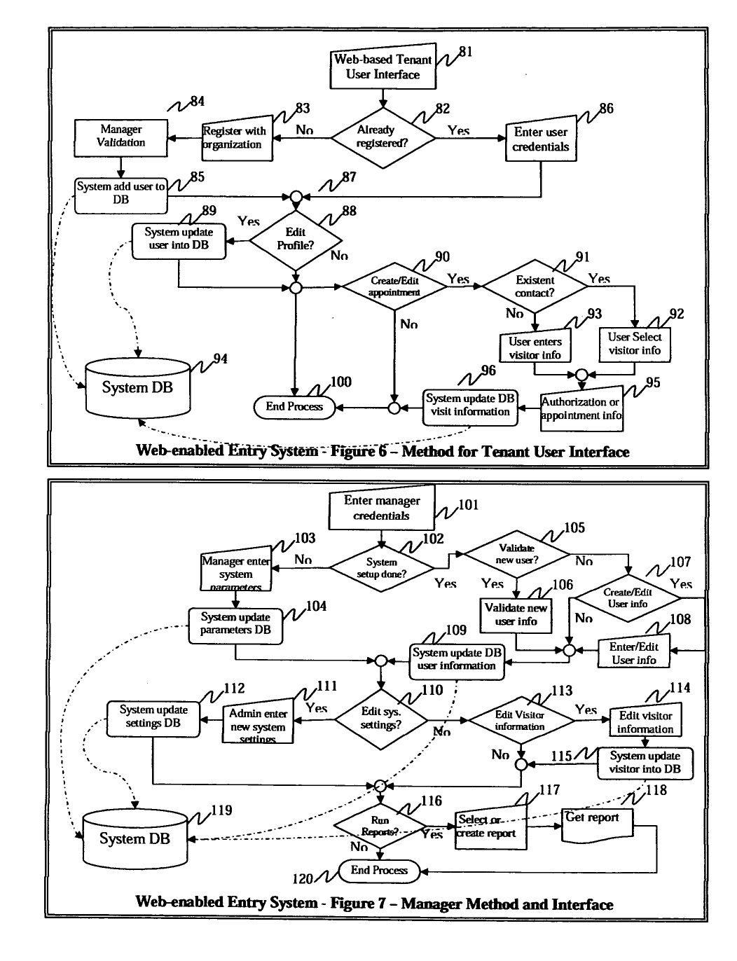

The FIG. 7 shows the method and process for manager (or managers), designated by the owner organization, for managing the service and entering data using just a web browser and then the web-enabled graphic user interface at the access server. One of the features of the system on this invention is the flexibility and easy to set up features at disposal of the facility manager. Using the manager credentials 101, if system has not been set up 102, the manager can easily set up 103 the parameters of the system according to their needs without the need to install any software. Once parameters have been set for the facility that information will be updated 104 in the system database.

Other tool available to the manager using the web-enabled system interface is to validate 105 new users. As explained above, users can register themselves in the system and then manager can validate that user 106. Other related feature is the ability to also directly create or edit 107 information of tenant users; such changes entered 108 by manager will be updated 109 in the database.

The manager is also provided by the system with options 110 to edit system settings 111 after the system was set up, some of those setting are related to preferred communication channels, and all changes will be updated 112 in the system database.

Manager also has the ability to create or edit 113 visitor information 114, when required, updating all such changes in the system database.

One more tool provided by the system to the manager is the ability to run reports 116 at will or automatic pre-scheduled reports 117 that will be available 118 in different formats like PDF⁸ or CSV⁹ among others. ⁸ PDF means a Portable Document Format.⁹ CSV means a text file with Comma Separated Values compatible with worksheet applications.

### PRIOR ART PATENTS

1. U.S. Pat. No. 6,853,709 Apparatus for direct communication with a phone entry system Feb. 8, 2005.
2. U.S. Pat. No. 6,728,351 Access control system having tenant codes that may be selectively displayed, Apr. 27, 2004.
3. U.S. Pat. No. 7,783,018 Directory display and configurable entry system, Aug. 24, 2010.
4. U.S. Pat. No. 7,404,517 Access Control System, Jul. 29, 2008.
5. U.S. Pat. No. 6,394,356 Access Control System, May 28, 2002
6. U.S. Pat. No. 7,377,426 Interactive visitor announcement/access control system, May 27, 2008
7. U.S. Pat. No. 7,222,241 Building security and access protection system, May 22, 2007

1. A cloud-enabled web-entry visitor access control system comprised by:
a. A touch capable tablet computer with wireless connectivity to Internet using a web-based or native software application with user interface for processing of access request of visitors to private or restricted-access facilities.
b. A remote access server system and database connected to Internet with the process and software that allows interactive processing of visitor access request, notification to visited users or hosts.
c. A remote multichannel communication server with process and software capable of generate notifications and responses via Short Message Service (SMS) text messages, IVR (Interactive Voice Response) calls, Voice over IP (VoIP) two-way audio communications and electronic mail (e-Mail) notification between Visitors, Guards, Receptionist and Hosts or Residents.
d. A method for automated processing of an access control visitor request using said tablet computer, said remote access server and said remote communication server.

2. The cloud-enabled web-entry visitor access control system of the claim 1 that optionally can include:
a. Processes and software applications to enable the capture of capture pictures and video clips of visitors using the cameras embedded in the tablet computers for processing visitors requests.
b. Means for remotely open a door, gate or elevator using computer commands via Internet to a door controller or Interface.
c. Process and software for remotely controlling via Internet the means to print a visitor label, visitor pass or visitor paper badge.

3. Methods for replacing the use of either manned or unmanned traditional visitor systems by using the cloud-enable web-entry visitor access control system of the claim 1, which allow:
a. Replacement of visitor telephone entry (tele-entry) systems and computer based visitor control systems typically assisted by a guard or receptionist.
b. Replacement the use of traditional PC based visitor systems connected to Local Area Network used for Guards or Receptionist for processing visitor systems in conjunction with telephone apparatus and other accessories.

4. Methods for automated visitors processing including using the said cloud-enable web-entry visitor access control system of the claim 1 whee such methods enable:
a. Capability for visitor self-checking, access approval request and automated notification.
b. Functionality for multilingual selection of notification language based on host individual preference.
c. Ability to generate a random meeting code to be used for visitor access pre-approved by host.
d. Capability to connect multiple visitor stations for a single facility using wireless connectivity to internet without the need of a LAN (local Area Network) or WAN (Wide Area Network).
